(19) United States
(12) Patent Application Publication
(10) Pub. No.: US 2007/0253035 A1
(43) Pub. Date: Nov. 1, 2007

(54) Image Processing Apparatus, Image Processing System, and Parameter Setting Method for Image Processing Apparatus

(75) Inventor: Yoshikazu TAKESADA, Itami-shi (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Tokyo (JP)

(21) Appl. No.: 11/564,444

(22) Filed: Nov. 29, 2006

(30) Foreign Application Priority Data
May 1, 2006 (JP) 2006-127687

(51) Int. Cl. H04N 1/32

(52) U.S. Cl. 358/468

(57) ABSTRACT

Provided is an image processing apparatus that provides a client terminal with a web contents file upon request by the client terminal. The client terminal displays a setting window based on the web contents file, and transfers to the image processing apparatus a file that has been dragged and dropped within a predetermined area of the setting window. The image processing apparatus analyzes the received file and rewrites the setting of the image processing apparatus in accordance with the analysis result.

This application is based on application No. 2006-127687 filed in Japan, the content of which is hereby incorporated by reference.

### BACKGROUND OF THE INVENTION

(1) Field of the Invention

The present invention relates to an image processing apparatus, an image processing system, and a parameter setting method for such an image processing apparatus. The present invention particularly relates to a technology of allowing a user connected to an image processing apparatus to set a setting parameter of the image processing apparatus by remote control.

(2) Related Art

As a method of remotely performing settings of an image processing apparatus, use of a web browser on a personal computer connected to the image processing apparatus via a network is already known (e.g. Japanese Patent Application Publication No. 2005-301610).

However these conventional technologies, although having achieved usability on the web browser, still lack intuitive usability that appeals to visual recognition, and so tend to be avoided by entry-level users who do not have sufficient knowledge about an image processing apparatus.

In addition, the items to be set for image processing apparatuses are increasing in number in accordance with the increase in variations of the functions installed in image processing apparatuses. Therefore it is required to set parameters for many setting items with a smaller number of operations.

### SUMMARY OF THE INVENTION

The present invention has been conceived in view of the above-stated problems, and has an object of providing an image processing apparatus, an image processing system, and a parameter setting method for the image processing apparatus, which enable a plurality of setting items of parameter to be set in parameter setting of an image processing remotely from a client terminal connected to the image processing apparatus, and of providing intuitive usability that appeals to visual recognition for the user.

So as to achieve the mentioned object, an image processing apparatus relating to one aspect of the present invention is an image processing apparatus connectable to a client terminal via a network, the image processing apparatus including: a storage unit operable to store a source file of a setting window to be displayed in the client terminal; a transmission unit operable to transmit the source file, the source file including a) a detection module that makes the client terminal detect a drag and drop operation of an icon to a predetermined area of the setting window displayed in the client terminal, and b) a transfer module that makes the client terminal transfer back a setting file corresponding to the icon that has been dragged and dropped; a setting file reception unit operable to receive the setting file transferred back from the client terminal; and a setting unit operable to set an image-processing related parameter that is included in the setting file, as a parameter of the image processing apparatus.

An image processing system relating to another aspect of the present invention is an image processing system including an image processing apparatus and a client terminal that are connected via a network, where the image processing apparatus includes: a storage unit operable to store a source file to be browsed in the client terminal; a transmission unit operable to transmit the source file, and the client terminal includes: a reception unit operable to receive the source file via the network; and a browsing unit operable to display contents of the source file, the source file including a) a detection module that makes the client terminal detect a drag and drop operation of an icon to a predetermined area of a setting window of the client terminal, and b) a transfer module that makes the client terminal transfer back a setting file corresponding to the icon that has been dragged and dropped, and where the image processing apparatus further includes: a setting file reception unit operable to receive the setting file transferred back from the client terminal; and a setting unit operable to set an image-processing related parameter that is included in the setting file, as a parameter of the image processing apparatus.

A parameter setting method for an image processing apparatus relating to further aspect of the present invention is a method of setting a parameter of an image processing apparatus in an image processing system, the image processing system including the image processing apparatus and a client terminal that are connected to each other via a network, the parameter setting method including: a reception step of receiving, by the client terminal, a source file of a setting window, the source file being transmitted from the image processing apparatus; a display step of displaying the setting window based on the received source file, the displaying step being performed by the client terminal; a detection step of detecting a drag and drop operation of an icon to a predetermined area of the displayed setting window, the detection step being performed by the client terminal; a transfer step of transferring, from the client terminal to the image processing apparatus, a setting file corresponding to the icon that has been dragged and dropped in the client terminal; a setting-file reception step of receiving the transferred setting file, the receiving step being performed by the image processing apparatus; and a setting step of setting an image-processing related parameter that is included in the setting file, as a parameter of the image processing apparatus, the setting step being performed by the image processing apparatus.

According to the image processing apparatus, the image processing system, and the parameter setting method, it becomes possible to provide an interface with intuitiveness that appeals to visual recognition.

In addition, by incorporating parameters respectively for numerous setting items in a setting file to be dragged and dropped, for example, it becomes possible to set parameters for a plurality of setting items with a smaller number of operations.

The image processing apparatus may further include a judgment unit operable to judge a parameter attribute of the setting file, where the setting unit sets the parameter of the image processing apparatus, based on the parameter attribute of the setting file.

Moreover, the image processing apparatus may further include: an operation panel unit including a display screen and a plurality of operation keys for receiving input from a user; and an operation-panel control unit operable to control the operation panel unit, wherein when the judgment unit has judged that the parameter attribute of the setting file is a destination setting regarding transmission from the image processing apparatus, the operation-panel control unit controls one of the operation keys as a one-touch key regarding the destination setting.

With the stated structure, a user is able to set a one-touch key with ease, without operating the operation panel unit by moving up to the image processing apparatus.

Furthermore, for an image processing apparatus designed to be shared by numerous users, it enables to avoid occurrence of users waiting in line due to one user occupying the operation panel unit for performing a complex setting on the operation panel unit, and the like.

The image processing apparatus may further include a facsimile unit operable to perform facsimile Transmission, wherein when the judgment unit has judged that the parameter attribute of the setting file is a destination number for the facsimile transmission, the operation-panel control unit controls one of the operation keys as a one-touch key regarding the destination number.

Moreover, the image processing apparatus may further include an image reading unit operable to read an original thereby generating image data for the facsimile transmission, where the operation-panel control unit brings the image reading unit into wait state preparing to read the original, as well as displaying the one-touch key.

With the stated structure, user usability improves.

The image processing apparatus may further include: a mailer unit operable to perform mail transmission, wherein when the judgment unit has judged that the parameter attribute of the setting file is a destination of the mail transmission, the operation-panel control unit controls one of the operation keys as a one-touch key regarding the destination.

Moreover, the image processing apparatus may further include an image reading unit operable to read an original thereby generating image data for the mail transmission, where the operation-panel control unit brings the image reading unit into wait state preparing to read the original, as well as displaying the one-touch key.

Moreover, in the image processing apparatus, the operation-panel control unit may temporarily display the one-touch key, and cancels the display of the one-touch key when the one-touch key is judged not to have been used for a predetermined duration.

With the stated structure, the display of a one-touch key is cancelled when a predetermined time has passed, and so the possibility of the one-touch key being used by other users than the user having set the one-touch key. Furthermore, by designing a one-touch key to be displayed temporally, it reduces the burden of canceling a one-touch key once set on the user. Therefore, the user would feel more free to set and use a one-touch key.

In the image processing apparatus, the operation-panel control unit may perform a countdown display of a remaining time until the display cancellation of the one-touch key.

Moreover, in the image processing apparatus, the operation-panel control unit may temporarily display the one-touch key, and cancel the display of the one-touch key when the one-touch key is judged to have been used.

With the stated structure, for example, a usage history of usage/non-usage (or the number of times of usage) of a one-touch key is managed for canceling the display upon usage. This enables cancellation of display of one-touch keys that have little possibility of being used, and leads to improvement in display usability.

The image processing apparatus may further include an identification unit operable to identify a user of the operation panel unit, where the operation-panel control unit controls to display a one-touch key regarding the identified user.

With the stated structure, by displaying strictly the one-touch key set by a user, it becomes possible to prevent occurrence of privacy/security problems. Furthermore, a user can easily find a one-touch key set by the user more easily.

The image processing apparatus may further include an XML analysis unit operable to analyze a file in XML format, where the setting file is described in XML format, and the judgment unit judges the parameter attribute of the setting file using a result of analysis performed by the XML analysis unit.

With the stated structure, a setting file is described in XML format. As a result, higher degree of flexibility and expandability are realized.

The image processing apparatus may further include an image reading unit operable to read an original thereby generating image data, where the setting file includes a parameter regarding an image reading condition used in reading the original, the image reading condition including a sheet size of the original and a resolution.

Moreover, in the image processing apparatus, a structure is also possible in which the source file further includes a judgment module that controls the client terminal to judge validity of the setting file that corresponds to the icon having been dragged and dropped, and the transfer module makes the client terminal transfer back the setting file if the judgment module has judged that the setting file is valid.

With the stated structure, it becomes possible to prevent a network traffic jam that is attributable to transfer of invalid setting files, and to reduce processing load for an image processing apparatus that normally has lower processing capability than that of client terminals.

In addition, an image processing apparatus relating to still further aspect of the present invention is an image processing apparatus connectable to a client terminal via a network, the image processing apparatus including: a storage unit operable to store a source file of a setting window to be displayed in the client terminal; a providing unit operable to provide the client terminal with the source file upon request by the client terminal; a detection unit operable to detect, using a detection function of the client terminal, a drag and drop operation of an icon directed to a predetermined area of the setting window that is displayed in the client terminal based on the source file; a transfer unit operable to transfer back, using a transfer function of the client terminal, a setting file that corresponds to the icon having been dragged and cropped; and a setting unit operable to set an image-processing related parameter that is included in the setting file, as a parameter of the image processing apparatus.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the drawings:

FIG. 1 is a diagram showing an overview of a system structure of an image processing system according to a first embodiment;

FIG. 2 is a functional block diagram showing a structure of the MFP 3;

FIG. 3 is a functional block diagram showing a structure of the PC 100;

FIG. 4 is a diagram showing an overview of a case where an administrator user sets an apparatus setting of the MFP 3 by using the PC 100 by remote control;

FIG. 5 is a diagram showing a window 130 of the web browser 112;

FIG. 6 is a diagram showing a desktop screen 139 of the monitor 102;

FIG. 7 is a diagram showing an overview of a “Sys_Management” file 153;

FIG. 8 is a flowchart showing processing executed by the web browser 112;

FIG. 9 is a flowchart showing the file contents analysis processing executed by the web browser 112;

FIG. 10 is a flowchart showing processing performed by the control unit 10 of the MFP 3 that has received a file transferred from the web browser 112;

FIG. 11 is a diagram showing the window 149 of the web browser 112 on which a completion notice is displayed;

FIG. 12 is a diagram showing a process overview in which a user sets a destination used in transmission from the PC 100 by remote control, and then moves up to the place where the MFP 3 is actually installed, and actually performs transmission destined to the destination;

FIG. 13 is a diagram showing a desktop screen 239 of a monitor 102;

FIG. 14 is a diagram showing an overview of a “SCAN_TO_Minoru” file 253;

FIG. 15 is a flowchart showing processing performed by the control unit 10 of the MFP 3 having received a destination setting file transferred from the web browser 112;

FIG. 16 is a flowchart showing Scan2email transmission one-touch key display processing executed by the control unit 10;

FIG. 17 is a diagram showing a display screen 54 of an operation panel unit 54, which is one example of the one-touch key display at Step S53;

FIG. 18 is an example of a flowchart of the modified structure of FIG. 15;

FIG. 19 is a diagram showing an MFP 3 and an authentication apparatus 300; and

FIG. 20 is a schematic diagram showing a manner in which a setting file 270 is generated by the XML converter 117 by converting the address book data 11.

### DESCRIPTION OF THE PREFERRED EMBODIMENTS

The following describes embodiments of the present invention with reference to related drawings.

### First Embodiment

### 1. Structure

1-1. System Structure

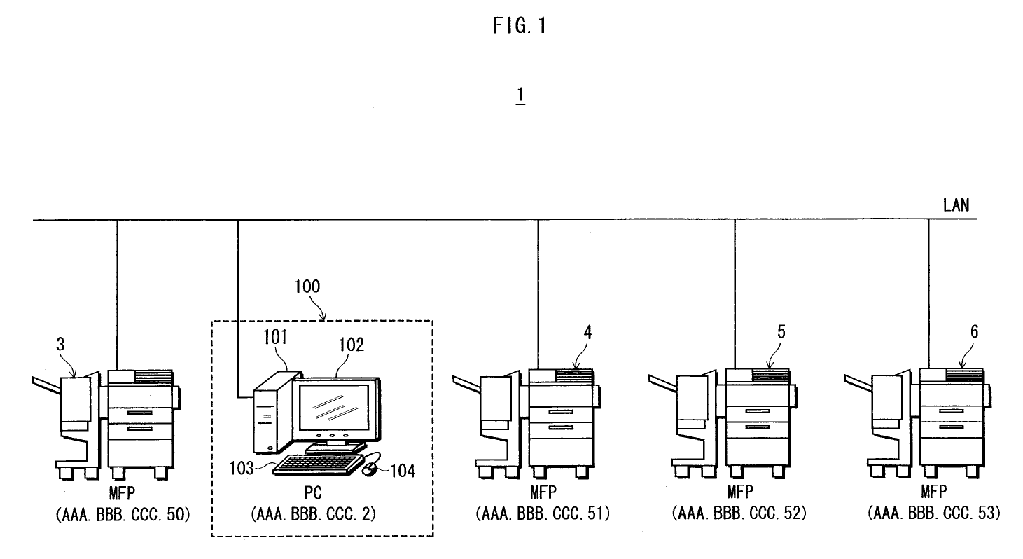

Referring to FIG. 1, an overview of a system structure of an image processing system according to a first embodiment will be described.

As shown in FIG. 1, an image processing system 1 is made up of four MFPs (multi function peripherals) 3-6 and a PC (personal computer) 100 that are connected via a LAN (local area network).

Each apparatus is respectively assigned a unique IP (internet protocol) address.

The PC 100 is composed of a PC main body 101, a monitor 102, a keyboard 103, and a mouse 104 in a two-button system.

1-2. Structure of MFP

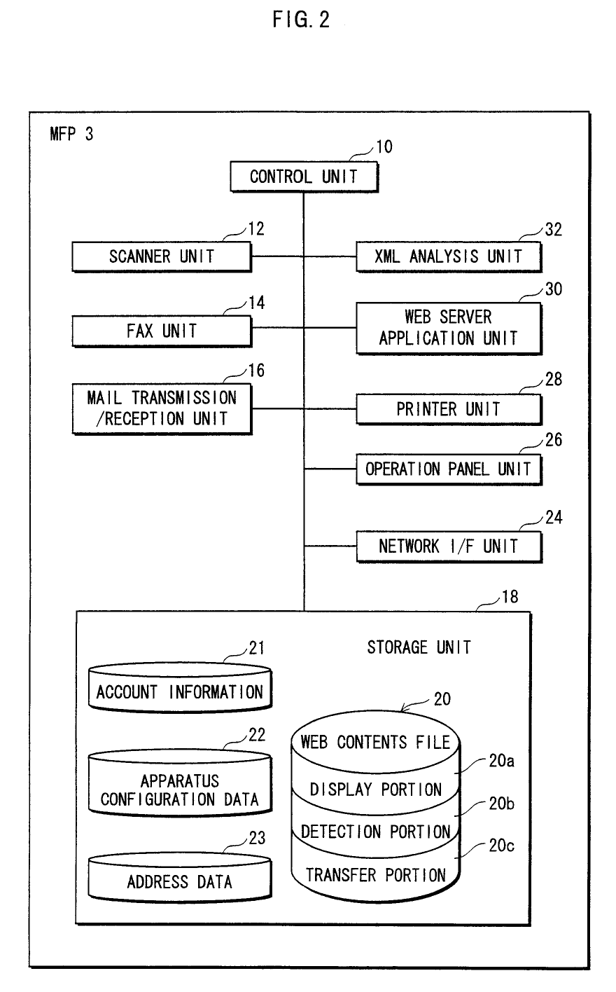

Referring to FIG. 2 being a functional block diagram, the structure of the MFP 3 will be described. Mote that the MFPs 4, 5, and 6 respectively have the same structure as the structure of the MFP 3.

The MFP 3 includes a control unit 10, a scanner unit 12, a FAX unit 14, a mail transmission/reception unit 16, a storage unit 18, a network I/F (interface) unit 24, an operation panel unit 26, a printer unit 28, a web server application unit 30, and an XML analysis unit 32.

The control unit 10 is a functional block that executes overall control over processing of each unit of the MFP 3, and performs such control as display control and input reception regarding the operation panel unit 26, and control of the web server application unit 30.

The scanner unit 12 reads an original placed on a sheet feeder (not shown in the drawing), thereby generating image data.

The FAX (facsimile) unit 14 performs FAX transmission/reception via a telephone circuit.

The mail transmission/reception unit 16 includes a mailer, and performs e-mail (electronic mail) creation, transmission, and reception.

From a hardware point of view, the storage unit 18 is structured by an HDD (hard disk drive) and an EPROM and the like. The storage unit 18 stores therein a web contents file 20, account information 21, apparatus configuration data 22, and address data 23.

The web contents file 20 is a source file of web contents browsed (or displayed) on the web browser.

In the present embodiment, the web contents file 20 is in the format of XML (extensible markup language), JavaScript is embedded in the web contents file 20 as a script language.

The web contents file 20 functionally includes a display portion 20a, a detection portion 20b, and a transfer portion 20c.

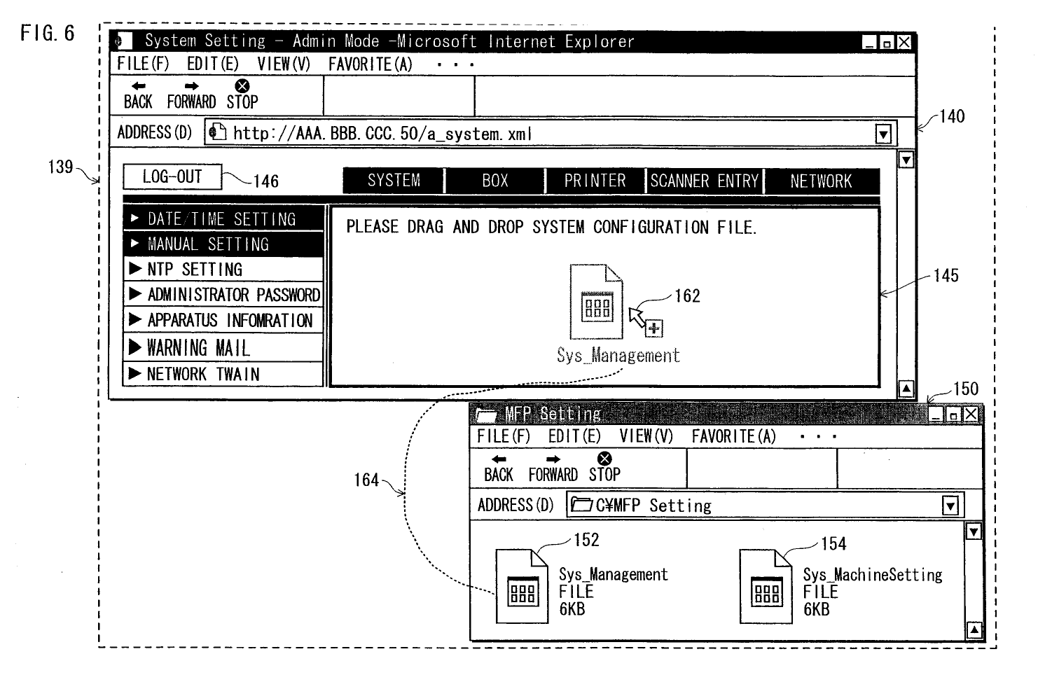

The display portion 20a is a source that has characters, images, frames, and the like displayed on the web browser, and is also a source of a setting window detailed later (see FIG. 6).

The detection portion 20b is a source that designates a part of a displayed window of the web browser as a drag and drop area, and detects a drag and drop of an icon directed to this area. Here, “icon” means a graphical image for representing a file, which specifically shows contents, functions, and a kind of program on which the file is executed, and the like.

A drag and drop area is specifically designated by coordinates of a rectangular area. In addition, event handlers such as “onmousedown” (press of a mouse button), “onmouseup” (release of a mouse button), and “onmousemove” (move of a mouse-cursor) are described within the source (the detection portion 20b), to enable detection of a drag and drop of an icon.

The transfer portion 20c obtains a file based on the file path of the icon that has been dragged and dropped, and analyzes the compatibility of the attributes and the contents of the file. Then when the analysis result of the file satisfies a predetermined condition, the transfer portion 20c transfers the file to the MFP 3 from a client PC browsing the content.

The account information 21 includes an apparatus account and a web server account.

The apparatus account is an account required to use the MFP 3 main body.

The web server account is an account required to log in to the web server, and has two types: one for the administrator, and the other for a general user.

The apparatus configuration data 22 is setting data that relates to the apparatus setting (e.g. power management).

The address data 23 is data that relates to destination (e.g. telephone number used in FAX Transmission and mail address used in mail transmission).

The network I/F unit 24 includes an NIC (network interface card), and is specifically an interface used in performing data transmission/reception with an external apparatus.

From a hardware point of view, the operation panel unit 26 is structured by a touch-panel display window, and press button keys. The operation panel unit 26 presents various displays to a user, as well as receiving operation input from the user.

The touch-panel display window of the operation panel unit 26 is not generally for swift key input, and so is required to simplify display as much as possible, and also to perform contents desired by a user with a smaller number of “presses” (touches).

The printer unit 28 performs printing processing to print out image data onto paper.

The web server application unit 30, upon reception of access (HTTP request) by the web browser, returns back a web contents file 20 to the web browser as a content.

The XML analysis unit 32 includes an XML parser, and analyzes data in XML format and converts it into a form available to other functional blocks.

1-3. PC Structure

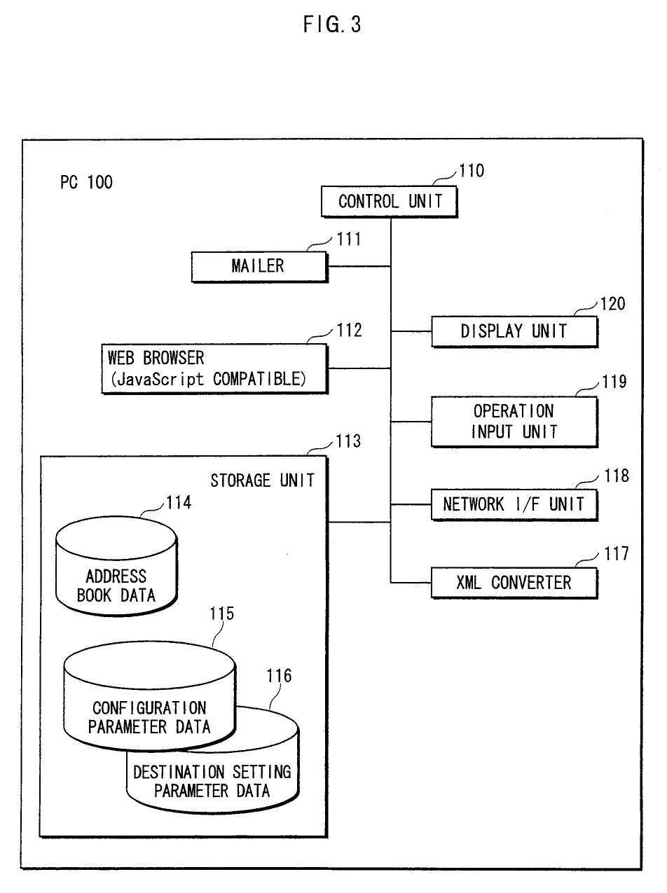

Referring to FIG. 3 being a functional block diagram, the structure of the PC 100 will be described.

The PC 100 includes a control unit 110, a mailer 111, a web browser 112, a storage unit 113, an XML converter 117, a network I/F unit 118, an operation input unit 119, and a display unit 120.

The control unit 110 exercises overall control over processing of each unit of the PC 100.

The mailer 111 is electronic mail software.

The web browser 112 is software that (1) obtains a web contents file by transmitting an HTTP request to a designated URL(Uniform Resource Locator), (2) analyzes the obtained web contents file, and (3) displays a web content regarding the web contents file, in format readable by the user.

The web browser 112 is able to execute a script language such as JavaScript contained in the obtained web contents file. In this sense, the web browser 112 is equipped with a script engine for JavaScript.

The storage unit 113 is structured by an HDD (Hard Disk Drive), and stores therein address book data 114, configuration parameter data 115, and a destination setting parameter data 116.

The address book data 114 is address book data for the mailer 111, and at least contains mail addresses on individual basis (or group basis). The address book data 114 may further contain such information as telephone number, address, company name, division name, and his/her position in the company.

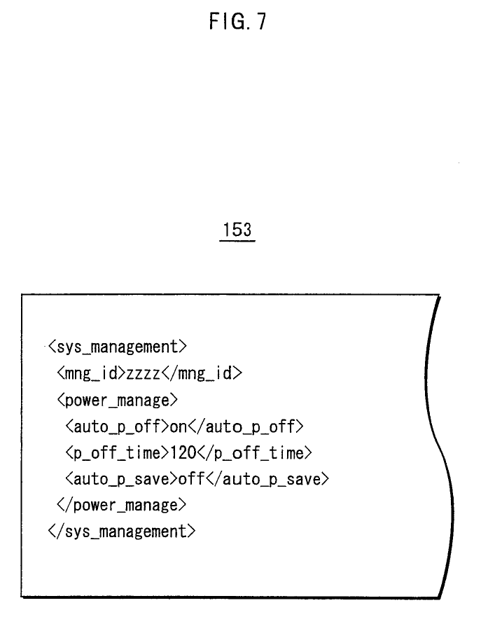

The configuration parameter data 115 includes a file in XML format in which a setting parameter for the purpose of setting the apparatus setting for the MFP 3 is described (see FIG. 7).

The destination setting parameter data 116 includes a file in XML format in which transmission destination addresses (i.e. destination) used by the MFP 3 in FAX transmission and mail transmission is described.

The XML converter 117 converts various types of data into XML format.

The network I/F unit 118 is an interface used in performing data transmission/reception with an external apparatus.

The operation input unit 119 is structured by such input devices as a keyboard 103 and a mouse 104 (see FIG. 1), and receives an operation input from a user.

The display unit 120 is structured by a monitor 102, and performs various types of display to the user.

### 2. Process of Apparatus Configuration for the MFP 3

2-1. Process Overview

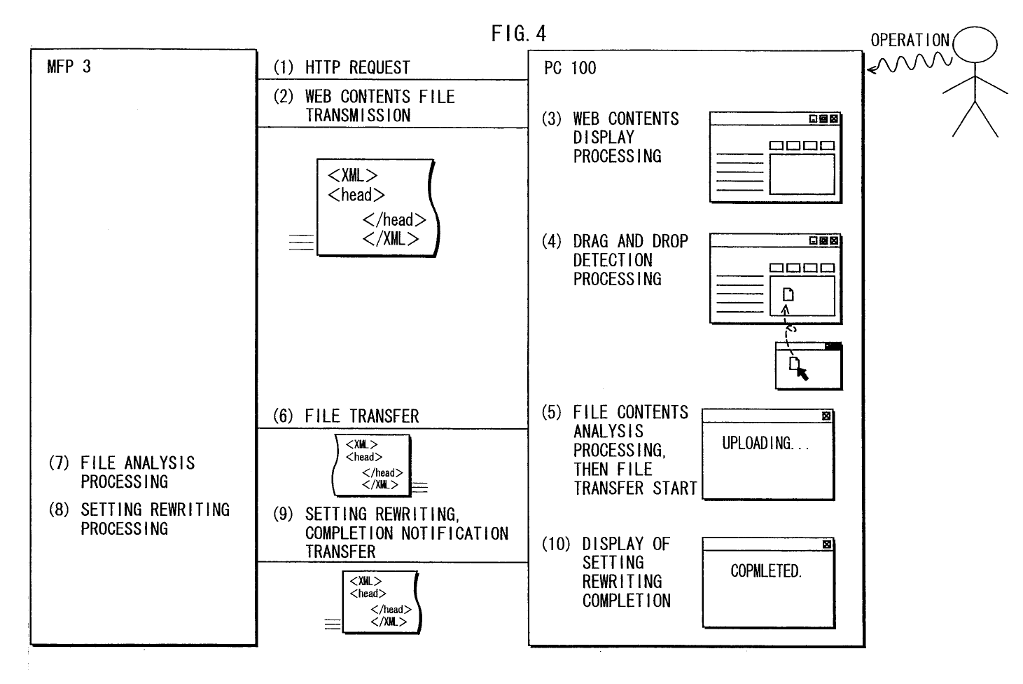

FIG. 4 is a diagram showing an overview of a case where a user A (administrator of the MFP 3) sets the apparatus setting of the MFP 3 by using the PC 100 (i.e. using the web browser 112) by remote control. Note that hereinafter in this specification, any similar expression to the above expression of “setting the apparatus setting of the MFP 3” is replaced by “performing the apparatus configuration for the MFP 3”.

As follows, simplified procedure is stated, and the details are described later.

### (1) The web browser 112 transmits an HTTP request to the MFP 3.

### (2) Upon reception of the HTTP request, the web server application unit 30 returns a web contents file to the MFP 3.

### (3) The web browser 112 analyzes the web contents file, and displays it as a web content.

### (4) Drag and drop of an icon to a predetermined area of a window is detected.

### (5) The contents of a file corresponding to the icon is analyzed.

### (6) The file is transferred (uploaded) from the PC 100 to the MFP 3.

### (7) The MFP 3 analyzes the transferred file.

### (8) The existing apparatus setting is rewritten in accordance with the file contents.

### (9) A web contents file for notifying setting rewriting completion is transmitted from the MFP 3 to the PC 100.

### (10) The web browser displays setting rewriting completion.

2-2. Web Browser Window

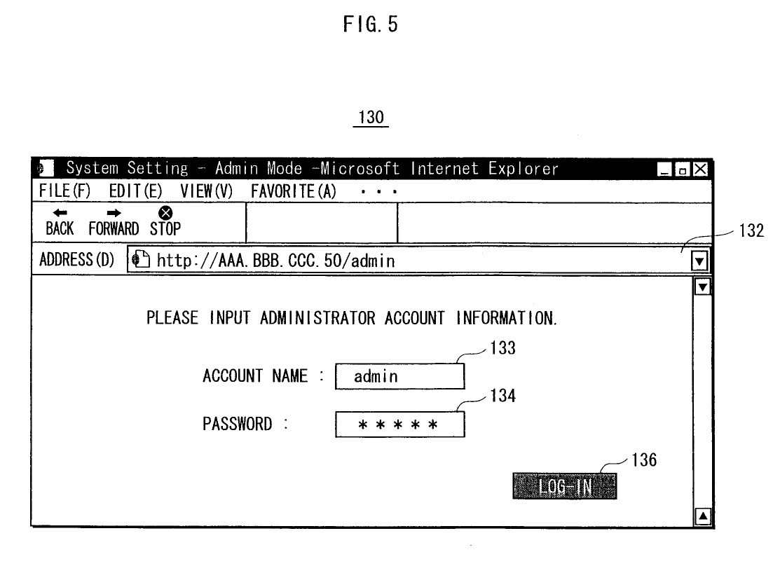

Referring to FIG. 5, a window 130 of the web browser 112 will be described.

The present embodiment is realized by using Internet Explorer (trademark), as the web browser 112. However alternatively, the present embodiment may be realized by using Firefox (trademark) and Opera (trademark), for example, as the web browser 112.

The URL of the address bar 132 is indicating the IP address “AAA.BBB.CCC.50” of the MFP 3.

The window 130 displays a box 133 for an account name and a box 134 for a password. When a log-in button 136 is pressed, character strings respectively inputted in the input boxes 133 and 134 are transmitted to the MFP 3. When the transmitted information matches the account information 21 of the MFP 3, then log-in as the administrator is enabled successfully.

Next, the web browser window and the apparatus configuration method, after the successful administrator Log-in, are detailed.

As shown in FIG. 6, the desktop screen 139 of the monitor 102 is displaying a window 140 of the web browser 112 and a window 150 of a filer.

A rectangular area 145 in the window 140 is a drag and drop area for receiving a drag and drop operation of an icon. In the area 145, a message stating “please drag and drop a system configuration file” is on display.

Note that when a log-out button 146 is “pressed”, log-out from the administrator mode is performed.

Within the window 150 of the filer, a “Sys_Management” file icon 152 and a “Sys_MachineSetting” file icon 154 are displayed. The file icons 152 and 154 respectively represent a file in which a setting parameter used in apparatus configuration is described.

FIG. 7 is a diagram showing an example of a “Sys_Management” file 153.

“Sys_Management” file 153 is a file that corresponds to the file icon 152, and in which a setting parameter regarding power management is described in XML format, where the power management is part of the apparatus setting.

The meaning of each tag is as follows.

<mng_id>: Administrator ID
<power_manage>: Power management
<auto_p_off>: whether automatic power-off is to be performed
<p_off_time>: a time at which automatic power-off is to be performed
<auto_p_save>: whether automatic power-saving is to be performed

Referring back to FIG. 6, the file icon 152 overlayed onto the mouse-cursor 162 is dragged within the area 145. Note that the dotted line 164 traces the route in which the mouse-cursor 162 is moved.

2-3. Processing at the Side of Web Browser 112

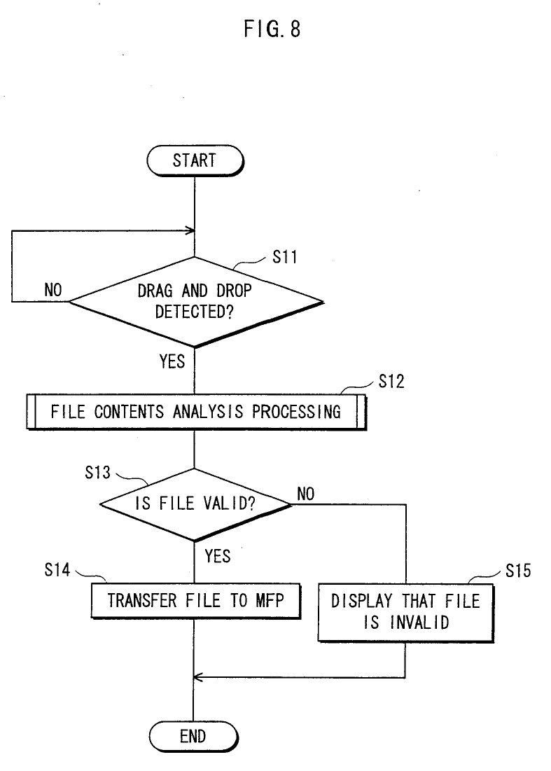

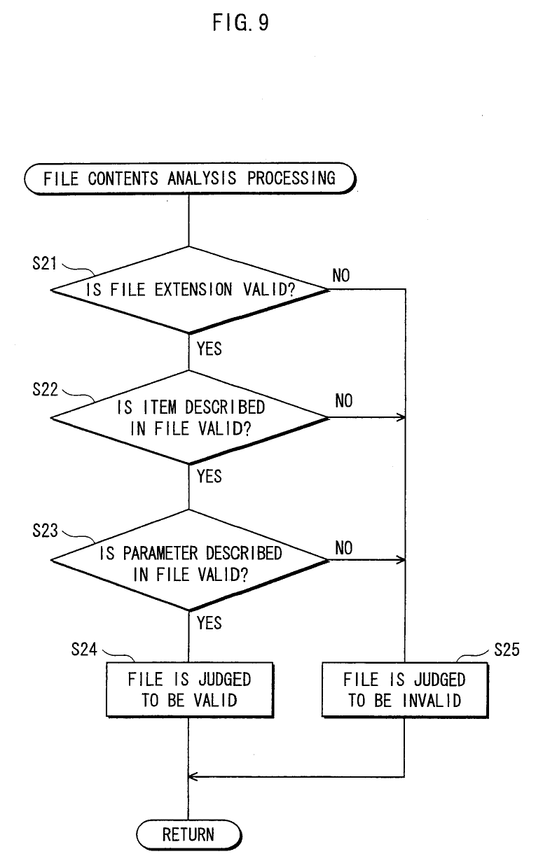

Referring to FIGS. 8 and 9, processing executed by the web browser 112 will be described.

The drag and drop detection in Step S11 is for example performed by undergoing the following steps of (1)-(2).

### (1) Detect move-in of the mouse-cursor dragging a file icon within the drag and drop area 145.

### (2) Detect a “drop” by the mouse-cursor within the area 145 (i.e. transition from the state in which the mouse button is pressed to the state in which the mouse button is released).

When a drag and drop is detected (S11:Yes), the control is moved to a sub routine shown in FIG. 9 in which file contents analysis processing (S12) is performed on the file that corresponds to the file icon that has been dragged and dropped.

The file contents analysis processing is processing to judge the compatibility of a file, which is to be performed prior to transfer of the file to the MFP 3. Specifically the file contents analysis processing is to prevent a meaningless file that does not contain any setting parameter or a file that contains malicious scripts from being transferred to the MFP 3 and from imposing a processing load on the MFP 3.

First of all, it is judged whether the file extension is valid or not (S21). Specifically, it is designed to be judged valid if the file has an extension of “.xml”, for example.

Subsequently, it is judged whether the item described in the file is valid or not (Step S22). Specifically, it is judged whether the tag described in the file is valid, for example.

Next, it is judged whether the parameter described in the file falls within a valid range or not (Step S23).

When these conditions are judged to be satisfied (S21:Yes, S22:Yes, and S23:Yes), then the file is judged to be valid (Step S24).

Returning back to the main routine of FIG. 8, when the file is valid (Step S13:Yes), the file is transferred to the MFP 3 (Step S14).

When the file is invalid (Step S13:No), a message reporting such is displayed (Step S15), where one example of the message states “the file is invalid, a drag and drop operation cannot be pursued”.

2-4. Processing at the Side of MFP 3

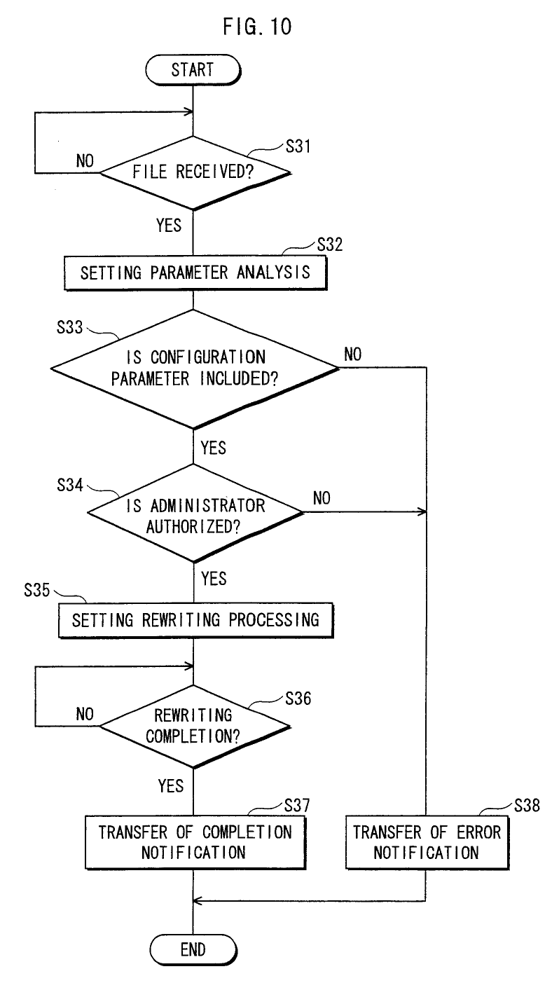

Referring to FIG. 10, processing performed by the control unit 10 of the MFP 3 that has received a file transferred from the web browser 112 will be described.

The control unit 10, upon reception of a file via the web server application unit 30 (Step S31:Yes), controls the XML analysis unit 32 to analyze a setting parameter found in the file (Step S32).

When the file contains a configuration parameter (Step S33:Yes) and the administrator is authorized (Step S34:Yes), the control unit 10 rewrites the existing setting in accordance with the setting of the setting parameter (Step S35). On the contrary, when the file does not contain any configuration parameter (Step S33:No) or the administrator is not authorized (Step S34:No), the control unit 10 controls the web server application unit 30 to transfer an error notification to the web browser 112 (Step S38), so that the web browser 112 can display a notice reporting such on the browser window.

Here, the judgment (Step S34) as to whether or not the administrator is authorized specifically includes (1) judgment as to whether the administrator ID matches, and (2) judgment as to whether the administrator's act lies within the predetermined authorized range.

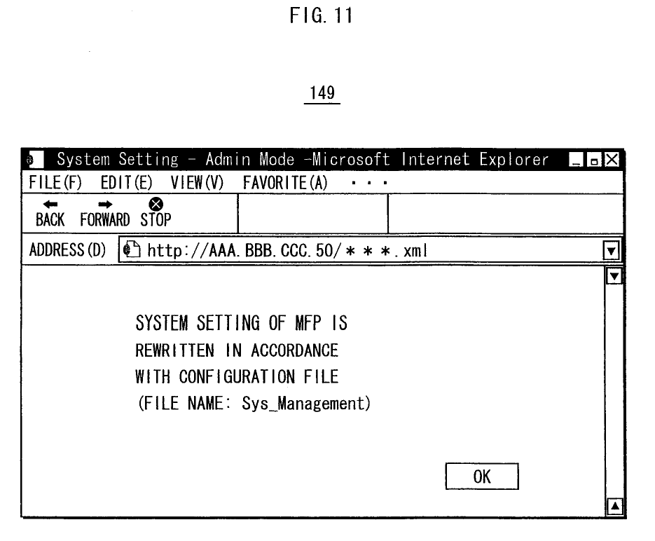

After completion of the rewriting (Step S36:Yes), a completion notification is transferred to the web browser 112 (Step S37), and the browser window displays a completion notice as shown in FIG. 11.

The window 149 is displaying a file name of the configuration file and a notice reporting that the existing system setting (i.e. apparatus setting) has been rewritten in accordance with the configuration file.

According to the present embodiment, the user A who is the administrator of the MFP 3 is able to change the apparatus setting of the MFP 3 only by performing a drag and drop operation of a configuration file icon within the area 145 of the window 140 of the web browser 112. Therefore, intuitive usability is realized.

In addition, if the user A is an administrator of MFPs 4, 5, and 6, then the user A is able to perform configuration of the MFPs only by performing a drag and drop operation of a configuration file icon of a corresponding MFP on a corresponding web browser window, after activating the three web browser windows (URL:http://AAA.BBB.CCC.51, URL:http://AAA.BBB.CCC.52, UJRL:http://AAA.BBB.CCC.53

### Second Embodiment

The overview of the second embodiment is such that the MFP 3 receives, from the web browser 112, a destination (address) setting file to be used in transmission processing performed by the MFP 3, and changes the display manner of the operation panel unit 26 of the MFP 3 according to the received setting file.

In the present embodiment, the structures of the MFP 3 and of the PC100 are the same as those described in the first embodiment, and so these structures are not described in the following description.

### 1. Destination Setting Process

1-1. Process Overview

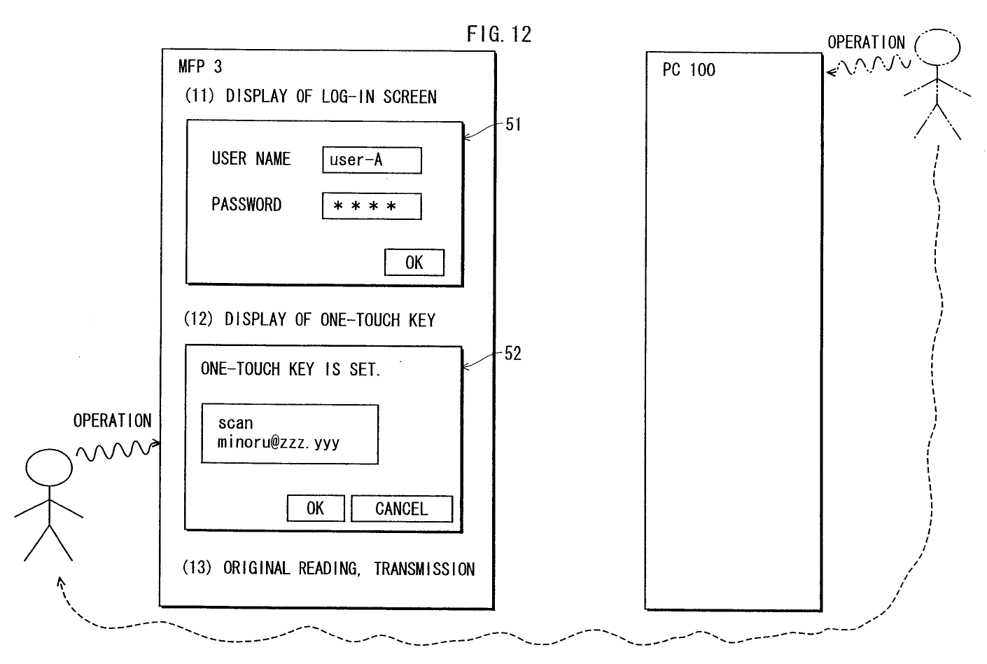

FIG. 12 is a diagram showing a process overview in which an operator user A, who is a general user of the MFP 3, sets a destination used in transmission to be performed from the MFP 3, by using the PC 100 by remote control, and then moves up to the place where the MFP 3 is actually installed, and actually performs transmission destined for the destination.

The first half of the present destination setting process (i.e. processing up to set, from the PC 100 by remote control, a destination used in transmission from the MFP 3) is substantially the same as the processes (1)-(10) described above with reference to FIG. 4, and so the description thereof is omitted.

### (11) The operation panel unit 26 displays a log-in screen 51 for receiving input of a user name and a password.

### (12) A transmission window 52 showing destination setting relating to the logged-in user as a one-touch key is displayed.

### (13) When the user has “pressed” the one-touch key thereby confirming the destination, the original placed on the sheet feeder is read to generate image data, and the image data is transmitted to the destination.

1-2. Web Browser Window

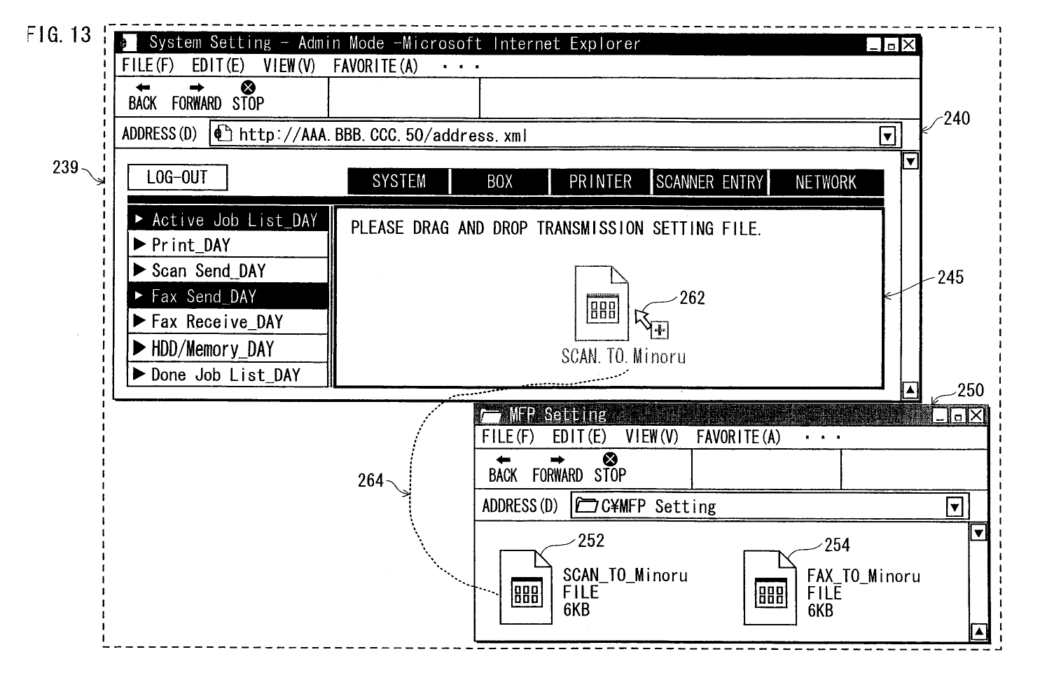

Referring to FIG. 13, a desktop screen 239 of a monitor 102 will be described.

The desktop screen 239 is displaying a window 240 of a web browser 112 and a window 250 of a filer.

A rectangular area 245 in the window 240 is a drag and drop area for receiving a drag and drop operation of an icon. In the area 245, a message stating “please drag and drop a transmission setting file” is on display.

Within the window 250 of the filer, a “SCAN_TO_Minoru” file icon 252 and a “FAX_TO_Minoru” file icon 254 are displayed. The file icons 252 and 254 respectively represent a file in which a setting parameter for destination setting is described.

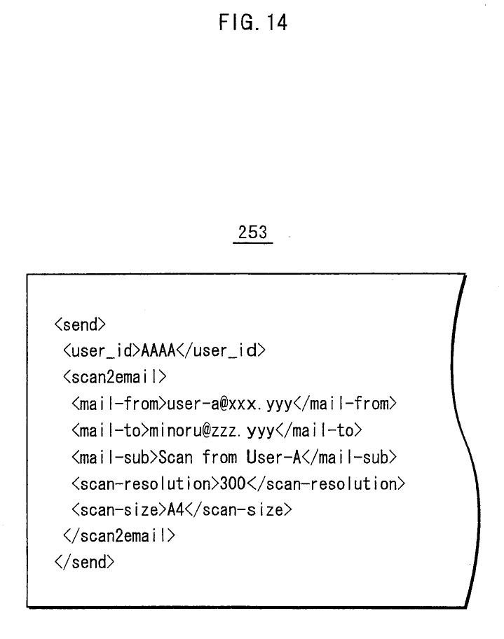

FIG. 14 is a diagram showing an example of a “SCAN_TO_Minoru” file 253.

The “SCAN_TO_Minoru” file 253 corresponds to the file icon 252.

The meaning of each tab is as follows.

<user_id> . . . user ID
<scan2email> . . . transmission method designation that designates to send an image obtained by scanning an original by mail (if the transmission method should be a FAX transmission, a tag of <FAX> is used).
<mail-from> . . . transmission source of mail
<mail-to> . . . transmission destination of mail
<mail-sub> . . . subject of mail
<scan-resolution> . . . resolution used in scanning
<scan-size> . . . size of an original to be scanned

Note that a “FAX_TO_Minoru” file is a destination setting file used in FAX transmission.

1-3. Processing at the Side of Web Browser 112

The processing performed by the web browser 112 is the same as described above in the first embodiment (see FIG. 8).

1-4. Processing at the Side of MFP 3

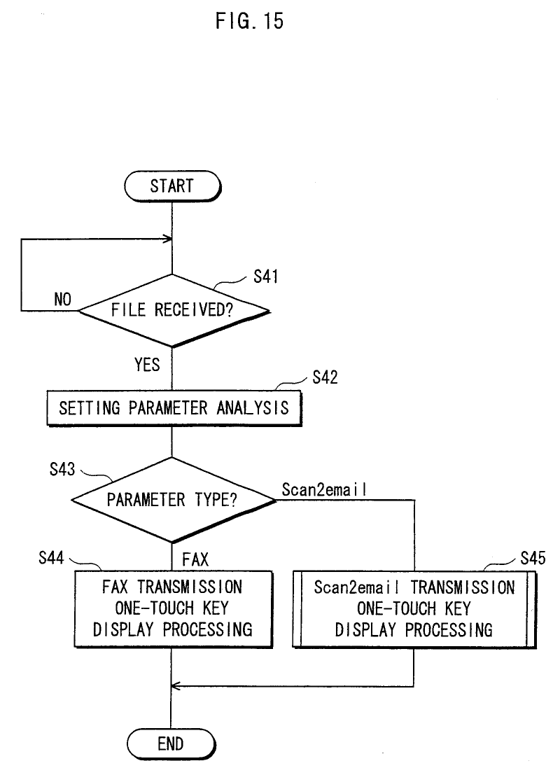

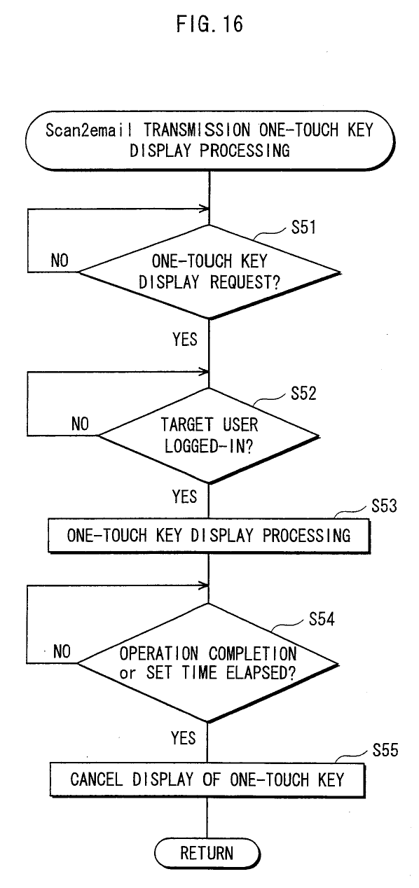

Referring to FIGS. 15 and 16, processing performed by the control unit 10 of the MFP 3 having received a destination setting file transferred from the web browser 112 will be described.

The control unit 10, upon reception of a file via the web server application unit 30 (Step S41:Yes), has the XML analysis unit 32 analyze setting parameters found in the file (Step S42).

In the subsequent step S43, a type of each of the parameters is judged. Specifically, it is judged as “FAX” if the parameter contains a telephone number, and it is judged as “Scan2email” if the parameter does not contain any telephone number.

When it is judged as “FAX” (Step S43:FAX), a FAX transmission one-touch key associated with the telephone number is displayed on the operation panel unit 26 (Step S44).

When it is judged as “Scan2email” (Step S43:Scan2email), a Scan2email transmission one-touch key display processing shown in FIG. 16 is carried out (Step S45).

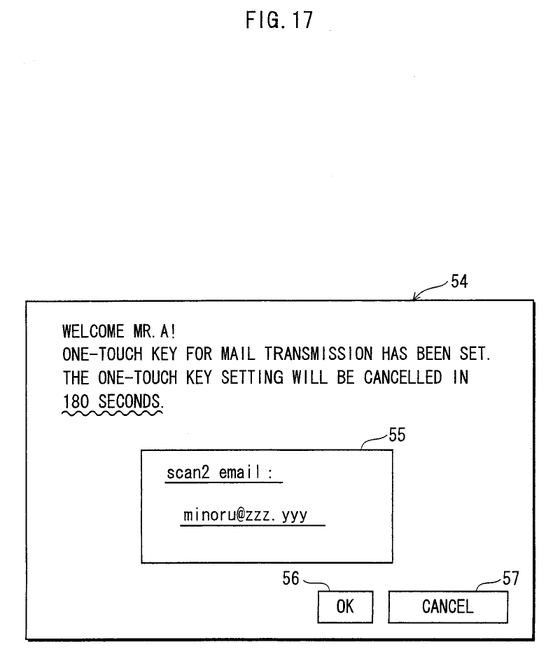

If there is a one-touch key display request (Step S51:Yes), and the operator user has logged in the MFP 3 (Step S52:Yes), the one-touch key is displayed on the operation panel unit 26 (Step S53) as shown in FIG. 17.

The display screen 54 has a touch panel function as stated above. A one-touch key 55, an “OK” key 56, and a “Cancel” key 57 are selectable upon reception of a “press” (touch).

The upper side of the display screen 54 shows a user name of a user currently logging in (operator user A) and a remaining time before cancellation of the one-touch key setting (180 seconds). This remaining time is decremented as time elapses.

The one-touch key 55 shows “scan2email” as a transmission method and “minoru@zzz.yyy” as a destination of the mail transmission.

Upon “pressing” of the “OK” key 56 while the one-touch key 55 is being selected by being “pressed”, the scanner unit 12 starts reading the original fed by the sheet feeder, thereby generating image data. Then the mail transmission/reception unit 16 creates mail to which image data is attached as a attachment file, and transmits the mail to the designated destination.

Returning back to FIG. 16, at Step S54, when transmission that uses the one-touch key has ended or when non-use of the one-touch key is confirmed, it is judged as an operation completion (Step S54:Yes), and the display of the one-touch key is cancelled (Step S55).

When the set time has elapsed (Step S54:Yes), the display of the one-touch key is likewise cancelled (Step S55). If the display cancellation is performed according to the elapsed time in this way, it reduces the possibility of the destination being known to or misused by other users than the user A.

As stated so far, according to the present embodiment, destinations used by the MFP 3 in mail transmission and FAX transmission are able to be set from the PC 100.

If the PC 100 is a terminal that the user A uses on a regular basis, it is possible to make an effective use of the address book used in mail transmission from the PC 100, also in transmission from the MFP 3.

### (Modifications)

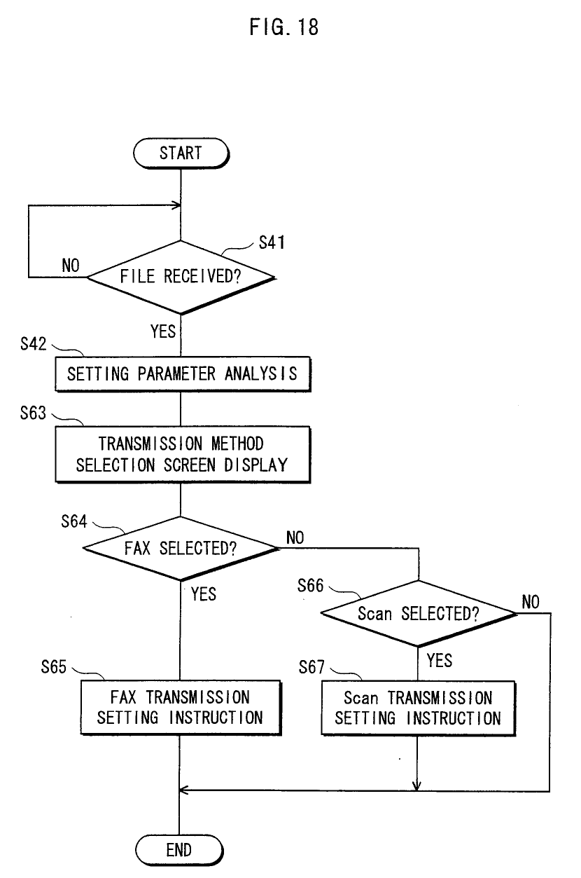

(1) In the second embodiment, a one-touch key is automatically displayed according to a parameter type (FIG. 15). However, a structure enabling a user to select the transmission method is also possible as shown in FIG. 18.

The first portion of the flow (Step S41-S42) of FIG. 18 is common to the counterpart of FIG. 15.

In Step S63, a transmission method selection screen is displayed. When FAX is selected (Step S64:Yes), a FAX transmission one-touch key is displayed (Step S65). On the contrary, when Scan is selected (Step S64:No, Step S66:Yes), a scan transmission one-touch key is displayed (Step S67).

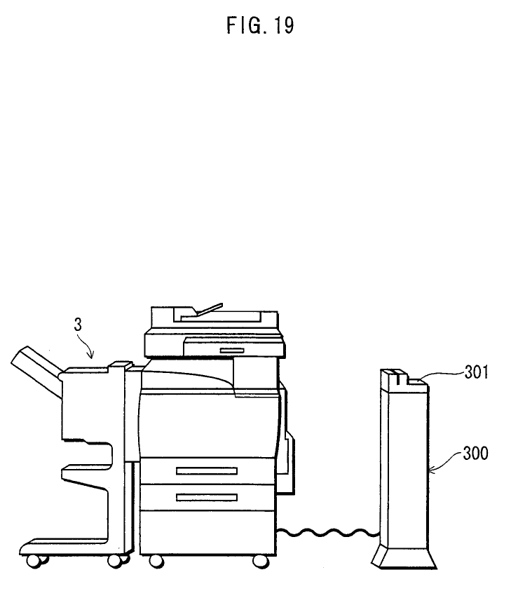

(2) In the second embodiment, log-in to the MFP 3 is performed using the log-in screen 51 of the operation panel 26. However, as shown in FIG. 19, it is alternatively possible to use, for the log-in, an authentication apparatus (current user identification apparatus) 300 connected to the MFP 3.

The authentication apparatus 300 is equipped with a card reading unit 301 in the upper portion of the package.

The card reading unit 301 authenticates a current user of the MFP 3 by reading magnetic information of the card having passed the reading slot.

(3) Although not detailed in the first and second embodiments, the setting file in XML format to undergo a drag and drop operation is for example generated as follows.

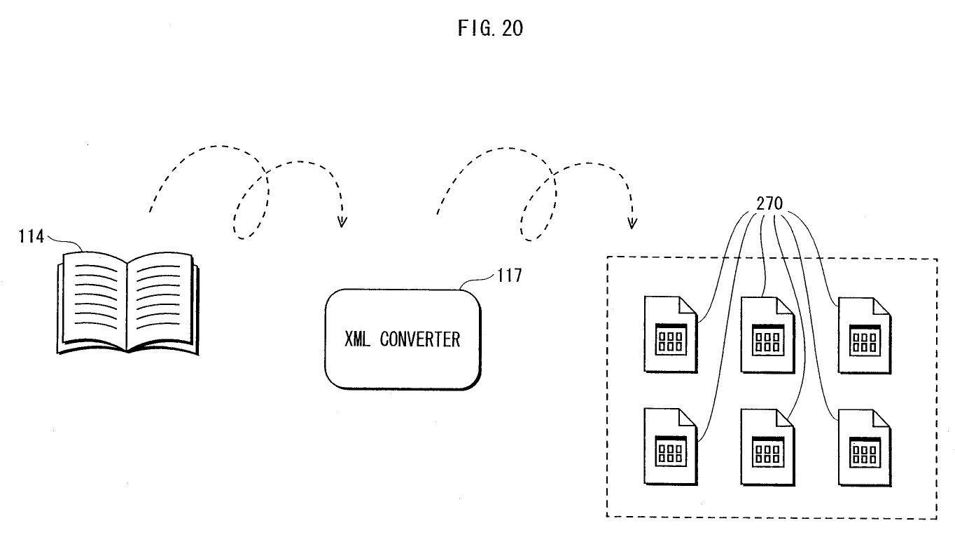

Referring to FIG. 20, a manner in which the XML converter 117 converts address book data 114 to generate a setting file 270 will be described.

The XML converter 117 analyzes the data found in the address book 114, thereby generating files in XML format that respectively describes individual names or mail addresses found in the address book. In this drawing, each file in XML format is named “file icon 270”.

(4) In the first and second embodiments, a desktop personal computer is taken as one example of a client (terminal). However the client (terminal) may alternatively be a personal digital assistant (PDA) equipped with a stylus pen as an input device.

Although the present invention has been fully described by way of examples with references to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. An image processing apparatus connectable to a client terminal via a network, the image processing apparatus comprising:
a storage unit operable to store a source file of a setting window to be displayed in the client terminal;
a transmission unit operable to transmit the source file, the source file including a) a detection module that makes the client terminal detect a drag and drop operation of an icon to a predetermined area of the setting window displayed in the client terminal, and b) a transfer module that makes the client terminal transfer back a setting file corresponding to the icon that has been dragged and dropped;
a setting file reception unit operable to receive the setting file transferred back from the client terminal; and
a setting unit operable to set an image-processing related parameter that is included in the setting file, as a parameter of the image processing apparatus.

2. The image processing apparatus of claim 1, further comprising:
a judgment unit operable to judge a parameter attribute of the setting file, wherein
the setting unit sets the parameter of the image processing apparatus, based on the parameter attribute of the setting file.

3. The image processing apparatus of claim 2, further comprising:
an operation panel unit including a display screen and a plurality of operation keys for receiving input from a user; and
an operation-panel control unit operable to control the operation panel unit, wherein
when the judgment unit has judged that the parameter attribute of the setting file is a destination setting regarding transmission from the image processing apparatus, the operation-panel control unit controls one of the operation keys as a one-touch key regarding the destination setting.

4. The image processing apparatus of claim 3, further comprising
a facsimile unit operable to perform facsimile transmission, wherein
when the judgment unit has judged that the parameter attribute of the setting file is a destination number for the facsimile transmission, the operation-panel control unit controls one of the operation keys as a one-touch key regarding the destination number.

5. The image processing apparatus of claim 4, further comprising
an image reading unit operable to read an original thereby generating image data for the facsimile transmission, wherein
the operation-panel control unit brings the image reading unit into wait state preparing to read the original, as well as displaying the one-touch key.

6. The image processing apparatus of claim 3, further comprising
a mailer unit operable to perform mail transmission, wherein
when the judgment unit has judged that the parameter attribute of the setting file is a destination of the mail transmission, the operation-panel control unit controls one of the operation keys as a one-touch key regarding the destination.

7. The image processing apparatus of claim 6, further comprising
an image reading unit operable to read an original thereby generating image data for the mail transmission, wherein
the operation-panel control unit brings the image reading unit into wait state preparing to read the original, as well as displaying the one-touch key.

8. The image processing apparatus of claim 3, wherein
the operation-panel control unit temporarily displays the one-touch key, and cancels the display of the one-touch key when the one-touch key is judged not to have been used for a predetermined duration.

9. The image processing apparatus of claim 8, wherein
the operation-panel control unit performs a countdown display of a remaining time until the display cancellation of the one-touch key.

10. The image processing apparatus of claim 3, wherein
the operation-panel control unit temporarily displays the one-touch key, and cancels the display of the one-touch key when the one-touch key is judged to have been used.

11. The image processing apparatus of claim 3, further comprising
an identification unit operable to identify a user of the operation panel unit, wherein
the operation-panel control unit controls to display a one-touch key regarding the identified user.

12. The image processing apparatus of claim 2, further comprising
an XML analysis unit operable to analyze a file in XML format, wherein
the setting file is described in XML format, and
the judgment unit judges the parameter attribute of the setting file using a result of analysis performed by the XML analysis unit.

13. The image processing apparatus of claim 1, further comprising
an image reading unit operable to read an original thereby generating image data, wherein
the setting file includes a parameter regarding an image reading condition used in reading the original, the image reading condition including a sheet size of the original and a resolution.

14. The image processing apparatus of claim 1, wherein
the source file further includes a judgment module that controls the client terminal to judge validity of the setting file that corresponds to the icon having been dragged and dropped, and
the transfer module makes the client terminal transfer back the setting file if the judgment module has judged that the setting file is valid.

15. An image processing apparatus connectable to a client terminal via a network, the image processing apparatus comprising:
a storage unit operable to store a source file of a setting window to be displayed in the client terminal;
a providing unit operable to provide the client terminal with the source file upon request by the client terminal;
a detection unit operable to detect, using a detection function of the client terminal, a drag and drop operation of an icon directed to a predetermined area of the setting window that is displayed in the client terminal based on the source file;
a transfer unit operable to transfer back, using a transfer function of the client terminal, a setting file that corresponds to the icon having been dragged and dropped; and
a setting unit operable to set an image-processing related parameter that is included in the setting file, as a parameter of the image processing apparatus.

16. An image processing system comprising an image processing apparatus and a client terminal that are connected via a network, wherein
the image processing apparatus includes:
a storage unit operable to store a source file to be browsed in the client terminal;
a transmission unit operable to transmit the source file, and
the client terminal includes:
a reception unit operable to receive the source file via the network; and
a browsing unit operable to display contents of the source file, the source file including a) a detection module that makes the client terminal detect a drag and drop operation of an icon to a predetermined area of a setting window of the client terminal, and b) a transfer module that makes the client terminal transfer back a setting file corresponding to the icon that has been dragged and dropped, and wherein
the image processing apparatus further includes:
a setting file reception unit operable to receive the setting file transferred back from the client terminal; and
a setting unit operable to set an image-processing related parameter that is included in the setting file, as a parameter of the image processing apparatus.

17. A method of setting a parameter of an image processing apparatus in an image processing system, the image processing system including the image processing apparatus and a client terminal that are connected to each other via a network, the parameter setting method comprising:
a reception step of receiving, by the client terminal, a source file of a setting window, the source file being transmitted from the image processing apparatus;
a display step of displaying the setting window based on the received source file, the displaying step being performed by the client terminal;
a detection step of detecting a drag and drop operation of an icon to a predetermined area of the displayed setting window, the detection step being performed by the client terminal;
a transfer step of transferring, from the client terminal to the image processing apparatus, a setting file corresponding to the icon that has been dragged and dropped in the client terminal;
a setting-file reception step of receiving the transferred setting file, the receiving step being performed by the image processing apparatus; and
a setting step of setting an image-processing related parameter that is included in the setting file, as a parameter of the image processing apparatus, the setting step being performed by the image processing apparatus.
